(19) United States
(12) Patent Application Publication
(10) Pub. No.: US 2017/0036482 A1
(43) Pub. Date: Feb. 9, 2017

(54) Tireless Skid Steer Wheels

(71) Applicant: 1434882 Alberta Ltd., Winnipeg (CA)

(72) Inventors: Derek Hird, Winnipeg (CA); Phil Bernardin, Winnipeg (CA)

(21) Appl. No.: 15/075,391

(22) Filed: Mar. 21, 2016

Related U.S. Application Data
(60) Provisional application No. 62/138,670, filed on Mar. 26, 2015.

(51) Int. Cl. B60B 15/02; B60B 27/02

(52) U.S. Cl. CPC B60B 15/02; B60B 27/02; B60B 2340/00; B60Y 2200/40

(57) ABSTRACT

A tireless steel wheel for a skid steer features a cylindrical drum, a set of cleats projecting externally from the drum, a hub plate inside the drum an at intermediate location between opposing ends thereof, frustoconical walls flaring outward from opposing sides of the hub plate toward the respective ends of the drum, and annular end plates joining the wider ends of the frustotonical walls to the drum at the opposing ends thereof. The hub plate is offset from an axial center of the drum, and the frustoconical walls are unequal to one another in their angle of taper. The annular walls prevent the wheels from digging into the ground, and the frustoconical walls prevent material accumulation inside the wheels. The offset position of the hub plate provides flexible mounting options to accommodate varying dimensional characteristics of different skid steer models and bucket sizes.

### CROSS REFERENCE TO RELATED APPLICATIONS

This application claims benefit under 35 U.S.C. 119(e) of Provisional Application Ser. No. 62/138,670, filed Mar. 26, 2016, the entirety of which is incorporated herein by reference.

### FIELD OF THE INVENTION

The invention relates generally to tireless wheels, and more specifically to tireless steel wheels that are mountable on a skid steer in place of the original pneumatic tires, thereby providing improved traction in muddy or other slip-prone conditions and eliminating the risk of tire puncture.

### BACKGROUND

In the prior art, it has been previously proposed to mount a set of circumferentially cleated steel drums externally over the conventional pneumatic tires of a skid steer machine as an alternative to equipping the machine with track suspension to provide improved traction and puncture prevention. Applicant is aware of such a product being marketed as the Womack Tire Track System, the details of which can be seen at http://womacktiretracks.com.

Use of cleated steel drums as wheels for working machines are also known in other fields, including trash and land compaction, road maintenance, and rail transport, as demonstrated by U.S. Pat. Nos. 1,372,633, 1,935,950, 2,315,397, 2,316,502, 3,450,013, 3,463,063, 3,823,983, 4,090,570, 4,530,620, 6,390,204, 7,066,682, 7,198,333, 8,690,475, and 305,337.

Cleatless and drumless designs of non-pneumatic tires and tireless wheels are also known, including those disclosed in U.S. Patent Application Publications 2008/0036286, 2010/0108215, 2014/0159280 and 2014/0251516 and International PCT Publication WO2014/36415.

Examples of known cleat designs and mounting solutions for same can be found in U.S. Pat. Nos. 3,964,797 and 6,540,310 and U.S. Patent Application Publication 2013/0147263.

Building upon the prior art, Applicant has developed a new and unique tireless wheels design for use on skid steer machines, the details of which are disclosed herein further below.

### SUMMARY OF THE INVENTION

According to one aspect of the invention there is provided a tireless skid steer wheel comprising:

a cylindrical drum closing around a central axis and spanning between opposing first and second ends of said cylindrical drum that are spaced apart along said central axis;

a plurality of cleats attached to the cylindrical drum and projecting externally therefrom at spaced apart positions around a circumference thereof;

a hub plate attached to, and disposed within, the cylindrical drum at an intermediate location between the opposing first and second ends thereof in an intermediate plane lying normal to the central axis;

a first frustoconical wall closing around the central axis on a first side of the hub plate with a wider end of said first frustoconical wall disposed in a first end plane lying normal to the central axis at or adjacent the first end of the cylindrical drum, and a narrower end of said first frustoconical wall disposed adjacent the hub plate in a first inner plane lying normal to the central axis and adjacent to the intermediate plane; and

a second frustoconical wall closing around the central axis on a second side of the hub plate with a wider end of said second frustoconical wall disposed in a first end plane lying normal to the central axis at or adjacent the second end of the cylindrical drum, and a narrower end of said second frustoconical wall disposed adjacent the hub plate in a second inner plane lying normal to the central axis and adjacent to the intermediate plane;

wherein the intermediate plane lies at an off center position located non-centrally between the first and second ends of said cylindrical drum along the central axis, and the first and second frustoconical walls are unequal to one another in an angle of taper measured between the wider and narrower ends of each frustoconical wall.

Preferably there is provided a first annular plate joining the wider end of the first frustoconical wall to the first end of the cylindrical drum; and a second annular plate joining the wider end of the second frustoconical wall to the second end of the cylindrical drum.

Preferably each cleat comprises a cleat plate having a length that lies axially of the drum and a width that lies radially of the drum, the plate comprising a pair of tabs that are disposed at spaced apart locations along the length of the plate are engaged into a respective pair of openings in the circumference of the drum.

Preferably each cleat further comprises a pair of gussets disposed on opposite sides of the cleat plate in a bracing relationship between the cleat plate and the circumference of the drum, and at least some of the openings in the circumference of the drum each comprise a first leg of the opening that lies axially of the drum to accommodate receipt of one of the tabs of the respective cleat and a second leg of the opening that is offset from the first leg in a circumferential direction to accommodate receipt of an additional tab on one of the gussets of the respective cleat.

Preferably the gussets comprise inner gussets that reside in a same plane as the hub plate.

Preferably the gussets comprise outer gussets that each reside closely adjacent a plane occupied by one of the annular end plates.

At least some of the cleats preferably have a mounting portion thereof that extends fully through a respective opening in the drum into a hollow interior space thereof, with the hub plate axially abutting said mounting portion inside the hollow interior space of the drum.

Preferably the cleats comprise a first group of cleats whose hub-plate mounting portions abut the hub plate from a first side thereof and a second group of cleats whose hub-plate mounting portions abut the hub plate from an opposing second side thereof.

Preferably the first group of cleats and the second group of cleats alternate with one another around the circumference of the drum.

Preferably all of the cleats have a hub-plate mounting portion.

Preferably the hub-plate mounting portion of each of said some of the cleats is gusset-shaped.

Preferably, at least some of the cleats have other end-plate mounting portions that extend fully through a respective opening in the drum into a hollow interior space thereof, and one of the annular plates abuts axially against each of said other mounting portions.

Preferably a length of cleat measured in an axial direction of the drum is less than an axial length of the drum and greater than ⅔ of said axial length of the drum, and the plurality of cleats are laid out in a staggered pattern in which sequentially adjacent cleats around the circumference of the alternate between a first position adjacent the first end of the drum and a second position adjacent the second end of the drum.

Preferably the hub plate has a spoked configuration featuring an inner portion in which a plurality of bolt holes are provided for mounting the tireless skid steer wheel to a wheel hub of a skid steer, and a plurality of radial spokes emanating outwardly toward the drum from the central portion at spaced apart positions around the central axis.

According to a second aspect of the invention there is provided a tireless skid steer wheel comprising:

a cylindrical drum closing around a central axis and spanning between opposing first and second ends of said cylindrical drum that are spaced apart along said central axis;

a plurality of cleats attached to the cylindrical drum and projecting externally therefrom at spaced apart positions around a circumference thereof;

a hub plate attached to, and disposed within, the cylindrical drum at an intermediate location between the opposing first and second ends thereof in an intermediate plane lying normal to the central axis;

a first frustoconical wall closing around the central axis on a first side of the hub plate with a wider end of said first frustoconical wall disposed in a first end plane lying normal to the central axis at or adjacent the first end of the cylindrical drum, and a narrower end of said first frustoconical wall disposed adjacent the hub plate in a first inner plane lying normal to the central axis and adjacent to the intermediate plane; and

a second frustoconical wall closing around the central axis on a second side of the hub plate with a wider end of said second frustoconical wall disposed in a first end plane lying normal to the central axis at or adjacent the second end of the cylindrical drum, and a narrower end of said second frustoconical wall disposed adjacent the hub plate in a second inner plane lying normal to the central axis and adjacent to the intermediate plane;

a first annular plate joining the wider end of the first frustoconical wall to the first end of the cylindrical drum; and

a second annular plate joining the wider end of the second frustoconical wall to the second end of the cylindrical drum.

According to a third aspect of the invention there is provided a tireless skid steer wheel comprising:

a cylindrical drum closing around a central axis and spanning between opposing first and second ends of said cylindrical drum that are spaced apart along said central axis; and

a plurality of cleats attached to the cylindrical drum and projecting externally therefrom at spaced apart positions around a circumference thereof;

a hub plate attached to, and disposed within, the cylindrical drum at an intermediate location between the opposing first and second ends thereof in an intermediate plane lying normal to the central axis;

wherein each cleat comprises a cleat plate extending axially of the drum and a pair of gussets abutted against the cleat plate on opposing sides thereof in a bracing relationship between the cleat plate and the circumference of the drum.

Preferably the drum comprises a respective pair of openings therein for each cleat, each opening comprising a first leg of the opening that extends axially of the drum and a second leg of the opening that is offset from the first leg in a circumferential direction of the drum, each cleat plate has a pair of tabs projecting from an edge of the plate into the respective pair of openings in the cylindrical drum, and each gusset has an additional tab thereof at a corner of the gusset defined between an edge of the gusset that abuts the cleat plate and an edge of the gusset that abuts the circumference of the drum, the additional tab projecting into one of the respective pair of openings at the second leg thereof.

According to a fourth aspect of the invention there is provided a wheel installation method for a skid steer having wheel hubs situated outboard from a main body of the skid steer, the method comprising:

(a) having a tireless skid steer wheel comprising a cylindrical drum, a plurality of cleats attached to the cylindrical drum and projecting externally therefrom at spaced apart positions around a circumference thereof, and a hub plate attached to, and disposed within, the cylindrical drum at an offset position from an axial center of the cylindrical drum such that a first axial measure of the drum from a first end of the drum to the hub plate is unequal to a second axial measure of the drum from an opposing second end thereof to the hub plate; and

(b) selecting which one of the ends of the drum to face toward the main body of a particular skid steer during installation according to dimensional characteristics of said particular skid steer;

(c) installing the wheel on the particular skid steer with the selected one of the ends facing toward the main body of the skid steer.

In one scenario, the first axial measure is greater than the second axial measure, and step (b) comprises (i) determining that only the second axial measure is less than an available clearance between a mounting face of the wheel hub and a side of the main body of the skid steer, and (ii) selecting the second end of the drum as the selected one of ends for facing toward the main body of the skid steer in step (c).

In another scenario, step (b) comprises (i) determining that a wheel-to-wheel vehicle width of the particular skid steer that would result from installation of the wheel in a second-end-in orientation facing the second end of the drum toward the main body of the skid steer would exceed a bucket width of the skid steer; and (ii) selecting the first end of the drum as the selected one of ends for facing toward the main body of the skid steer in step (c).

In another scenario, step (b) comprises (i) determining that a wheel-to-wheel vehicle width of the particular skid steer that would result from installation of the wheel would be less than a bucket width of the skid steer regardless of which end of the drum is faced toward the main body of the skid steer during installation; and (ii) selecting which end of the drum to face toward the main body in the skid steer in step (c) based as that which will result in the greater wheel-to-wheel vehicle width.

### BRIEF DESCRIPTION OF THE DRAWINGS

Preferred embodiments of the invention will now be described in conjunction with the accompanying drawings in which:

FIG. 1 is an assembled isometric view of a tireless steel wheel according to a first embodiment of the present invention.

FIG. 2 is an exploded isometric view of the tireless steel wheel of FIG. 1.

FIG. 3 is a side elevational view of the tireless steel wheel of FIG. 1.

FIG. 4 is a cross-sectional view of the tireless steel wheel of FIG. 3, as viewed along line A-A thereof.

FIGS. 5A and 5B are elevational and isometric views, respectively, of a drum of the tireless steel wheel of FIG. 1.

FIGS. 6A and 6B are elevational and isometric views, respectively, of a cleat plate of the tireless steel wheel of FIG. 1.

FIGS. 7A and 7B are elevational and isometric views, respectively, of a cleat gusset of the tireless steel wheel of FIG. 1.

FIG. 8 is a partial cross-sectional view of the tireless steel wheel of FIG. 4, as viewed along line B-B thereof.

FIGS. 9A and 9B illustrate installation of the cross-sectioned tireless wheel of FIG. 4 on the wheel hub of a skid steer based on available clearance between the wheel hub and main body of the skid steer.

FIGS. 10A and 10B illustrate mounting of a full set tireless steel wheels of the present invention on a skid steer in two different orientations.

FIGS. 10C and 10D illustrate mounting of a full set tireless steel wheels of the present invention in two different orientations on a skid steer of different dimensional characteristics than that of FIGS. 10A and 10B.

FIG. 11 is a side elevational view of a tireless steel wheel according to a second embodiment of the present invention

FIG. 12 is a cross-sectional view of the tireless steel wheel of FIG. 11, as viewed along line A-A thereof.

FIGS. 13A and 13B are elevational and isometric views, respectively, of a drum of the tireless steel wheel of FIG. 11.

FIGS. 14A and 14B are elevational and isometric views, respectively, of one cleat plate of the tireless steel wheel of FIG. 11.

FIGS. 15A and 15B are elevational and isometric views, respectively, of another cleat plate of the tireless steel wheel of FIG. 11.

In the drawings like characters of reference indicate corresponding parts in the different figures.

### DETAILED DESCRIPTION

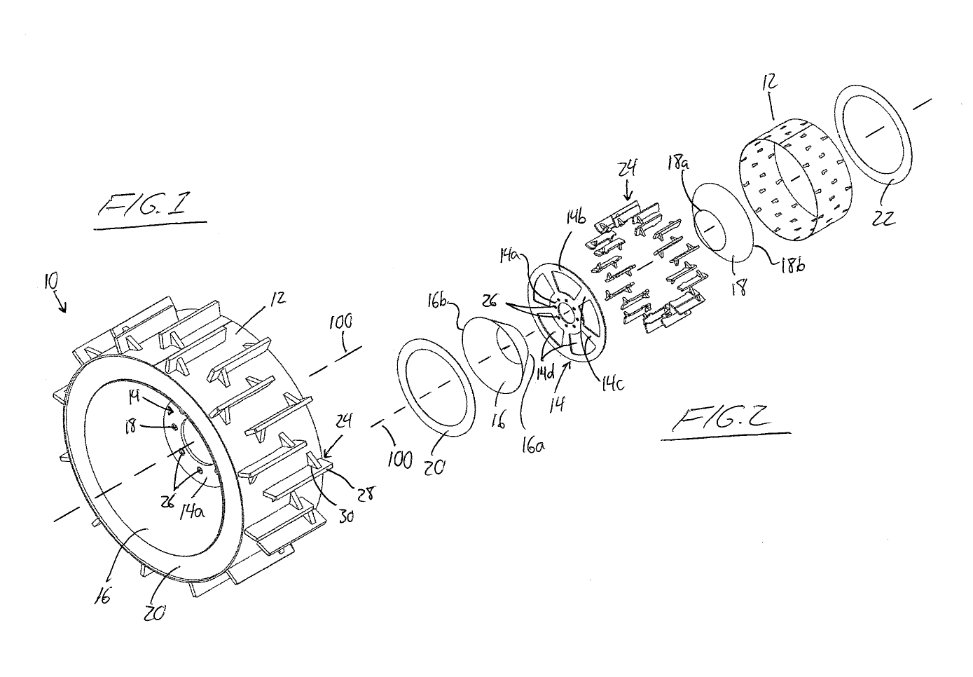

With reference to the drawings, a tireless wheel 10 according to a first embodiment of the present invention is made up of a cylindrical steel drum 12, a steel hub plate 14, a first frustoconical steel wall 16, a second frustonical steel wall 18, a first annular steel end plate 20, a second annular steel end plate 22, and a plurality of steel cleats 24. With reference to the assembled views of the wheel in FIGS. 1, 3 and 4, the cylindrical drum 12 closes concentrically around a central axis 100 of the wheel 10 to define a hollow interior of the drum in which the hub plate 14 and frustoconical walls 16, 18 are mounted, while the cleats 24 are externally mounted to the drum 12 at regularly spaced intervals around the circumference thereof.

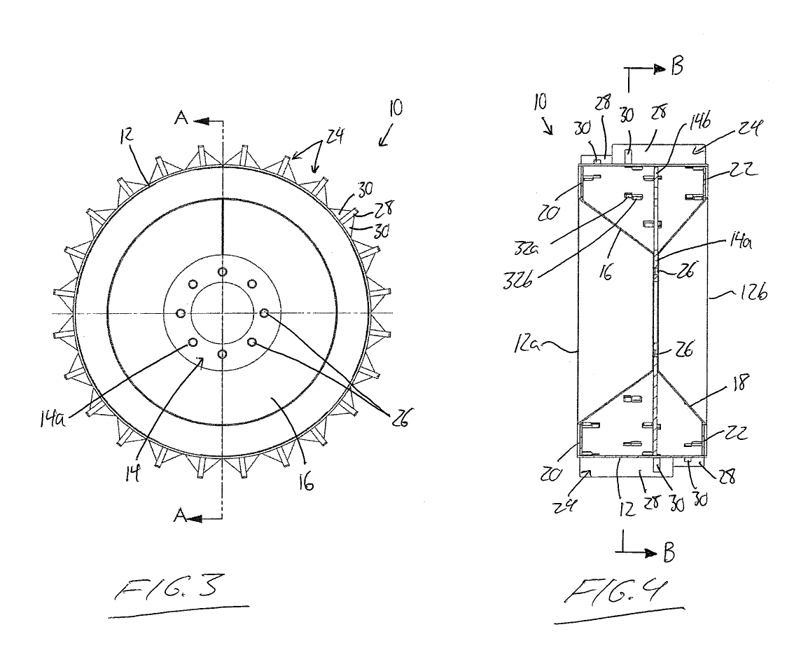

As best shown in FIG. 4, the hub plate 14 resides at an intermediate position between first and second ends 12a, 12b of the drum 12, which are spaced apart from one another along the central axis 100. Rather than being centered between these two ends 12a, 12b of the drum, the hub plate 14 is instead offset to one side of this axial center, whereby the hub plate resides further from the first end 12a of the drum than from the second end 12b thereof. With reference to FIG. 2, the hub plate 14 of the illustrated embodiment has a spoked shape, featuring an annular inner portion 14a, a larger annular outer portion 14b and a plurality of spokes 14c emanating radially outward from the inner portion 14a to the annular outer portion 14b at spaced apart locations around the central axis 100. Each pair of adjacent spokes are therefore separated by a respective opening 16, whereby the openings 14d reduce the overall weight of the hub plate 14 compared to a fully intact, solid plate design. However, a fully solid hub plate could alternatively be used in place of the lighter weight spoked design. A plurality of bolt holes 26 open axially through the annular inner portion 14a of the hub plate 14 at equally spaced positions around the central axis 100 for the purpose of accepting respective wheel bolts during mounting of the wheel 10 on the wheel hub of a skid steer, as described herein further below.

The first frustoconical wall 16 has its narrower-diameter end 16a abutted up against the hub plate 14 on a first side thereof in concentric alignment around the central axis 100. This narrower end 16a of the first frustoconical wall 16 is affixed to the inner portion 14a of the hub plate 14 on a first side thereof, for example by welding, at a short radial distance outward from the bolt holes 26. The wider end 16b of the first frustoconical wall 16 resides in the plane of the first end 12a of the drum at a radial distance inward therefrom. At this wider end 16b, the first frustoconical wall 16 is joined to the outer drum 12 by the first annular end plate 20, which is affixed to the outer surface of the first frustoconical wall 16 and the internal surface of the drum 12, for example by welding, so as to span radially therebetween.

On an opposing second side of the hub plate 14, The second frustoconical wall 18 likewise has its narrower-diameter end 18a abutted up against the inner annular portion 14a of the hub plate 14 in concentric alignment around the central axis 100. This narrower end 18a of the second frustoconical wall 16 is affixed to the inner portion 14a of the hub plate 14, for example by welding, at the same radial distance from the central axis 100 as the inner end 16a of the first frustoconical wall 16. The wider end 18b of the second frustoconical wall 18 resides in the plane of the second end 12b of the drum 12 at the same radial distance inward therefrom as the wider end of the first frustoconical wall 16. At this wider end 18b, the second frustoconical wall 18 is joined to the outer drum 12 by the second annular end plate 22, which is identical to the first annular end plate 20 and is likewise affixed between the wider end of the respective frustoconical wall 18 and the surrounding drum 12. Since the two annular end plates 20,22 are the same size, and the hub plate 14 is closer to the second end 12b of the drum 12 than to the first end 12a, the angle of taper of the second frustoconical wall 18 is greater than that of the first frustoconical wall 16.

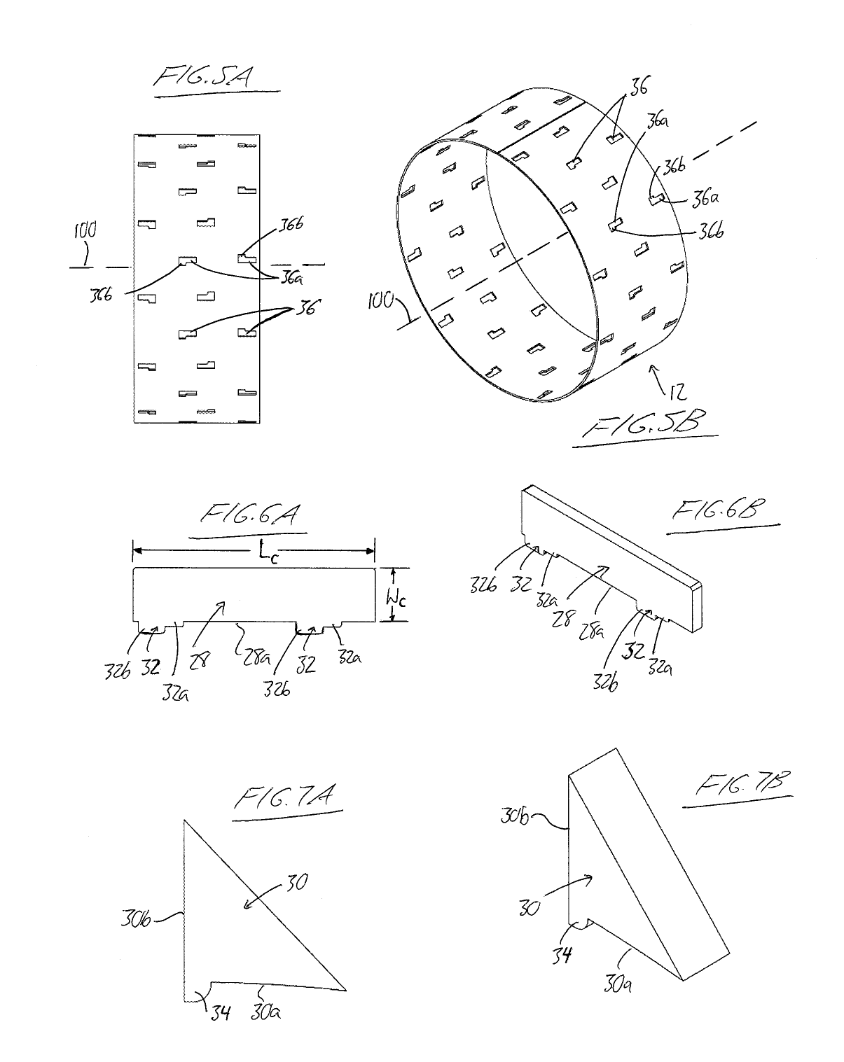

Each cleat 24 features a generally rectangular plate 28 and a pair of gussets 30 disposed on opposing sides thereof. With reference to FIG. 6, the cleat plate 28 is longer than it is wide. In the cleat plate's installed position, its length L_{C} extends axially of the drum in parallel relation to the central axis 100, while its width W_{C} lies radially of the drum to project outwardly therefrom. On the lengthwise edge 28a of the cleat plate 28 nearest to the drum 12, the cleat plate 28 deviates from its otherwise rectangular shape via the presence of two mounting tabs 32 that jut outwardly from the remainder of this lengthwise edge 28a. The cleat length L_{C} is less than the axial length of the drum, but greater than ⅔ the drum length. The cleats are laid out in a staggered pattern in which sequentially adjacent cleats around the circumference of the alternate between a first position adjacent the first end of the drum and a second position adjacent the second end of the drum.

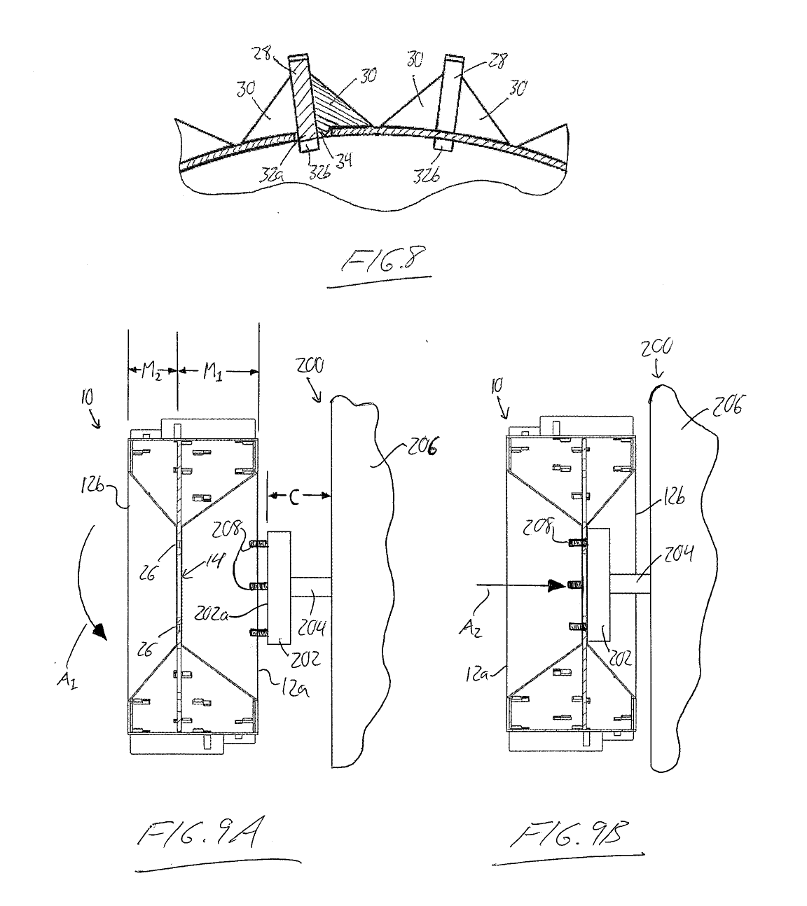

Turning to FIG. 7, each gusset 30 is in the form of a generally triangular plate, but deviates from a truly triangular shape in the presence of an arcuate curvature at the edge 30a thereof nearest the drum 12, and a small nub 34 projecting from this edge at what would otherwise be a right angle corner if the gusset was purely triangular. The radius of curvature of the curved edge 30a matches that of the drum's outer surface, whereby this edge of the gusset 30 conforms to the outer circumference of the drum in the installed position of the cleat 24. The other edge 30b of the gusset that extends out from the nubbed corner thereof is a flat edge that abuts flush against a face of the respective cleat plate 28 in the installed position of the cleat.

With reference to FIG. 5, each cleat 24 is mounted to the drum 12 at a respective pair of L-shaped holes 36 that open radially through the drum 12. Each hole 36 features a first leg 36a that lies axially of the drum (i.e. parallel to central axis 100) and a second leg 36b that lies circumferentially of the drum 12 and central axis 100. In each pair of holes 36, the second legs 36b of the two holes extend in opposite circumferential directions about the central axis 100. The first leg 36a of each hole receives a respective one of the two tabs 32 of the respective cleat plate 28, and the second leg 36b of each hole 36 receives the nub 34 of a respective one of the two gussets 30 of the same cleat 24. The nub therefore serves as an additional tab to positively locate the gusset during assembly of the wheel, just as the two tables of the cleat plate 28 positively determine the installed position of the cleat plate. During manufacture of the wheel 10, mounting of each cleat to a respective pair of predefined holes in the drum 12 in this manner automatically places the cleat plate 28 in proper axial alignment on the drum, and automatically places the flat edge 30b of each gusset 30 against a respective one of the cleat plate's two opposing faces, whereupon the cleat plate and gussets can be welded to the drum 12, and to one another, in order to complete the finished cleat structure and affix the same to the drum. The L-shaped mounting holes 36 for the cleats can be prefabricated into a flat-plate drum blank with great precision, for example using a CNC milling machine, laser cutter or water jet cutter, prior to roll-forming and welding of the drum into its final cylindrical shape, thereby enabling accurate positioning of the cleat components using simple manual placement during subsequent assembly steps in the manufacturing process.

In the first illustrated embodiment, each cleat tab 32 has two distinct portions 32a, 32b of different depth. A shallower portion of the tab 32 resides in the portion of the first leg 36a of the hole 36 that opens to the second leg 36b of the hole. A deeper portion 32b of the tab 32 occupies the remainder of the first leg 36a. As shown, the depth of the nub 34 on each gusset equals the depth of the shallower portion 32a of each cleat tab 32. As best seen in FIG. 8, the gusset nub 34 and shallower portion 32a of the respective plate tab 32 have a depth equal to the plate thickness of the drum, while the depth of the deeper portion 32b of each cleat tab 32 exceeds the plate thickness of the drum. As a result, only the only the deeper portion 32b of each tab 32 extends radially into the hollow interior space of the drum 12. With reference to FIG. 4, this allows the hub plate 14 to reside at a common plane with the second legs 36b of the some of the mounting holes 36 while still allowing the outer periphery of the hub plate 14 to abut against the inner surface of the drum 12 in its final position welded thereto.

During assembly of the wheel, the first set of cleats intended to reside at the first end 12a of the drum are installed prior to the other second set of cleats that will be subsequently installation at the second end 12b of the drum to create the staggered cleat pattern of the finished wheel. After the first set of cleats are installed, the hub plate 14 is ready to install. The deeper portions 32b of the tabs 32 on the first set of cleats that reside in the holes 36 at the plane of the hub plate's intended final position form a set of stops against which the hub plate 14 is axially abutted under sufficient insertion of the hub plate axially into the drum from the second end 12b thereof. Abutted against the deeper portions 32b of these tabs 32, the hub plate 14 is welded or otherwise fixed in this position. For a given location of the tab along the length of the cleat plate, the stepped shape of the variable depth tab 32 allows the hub plate 14 to be positioned by the tab at a location nearer to the central plane of the wheel than would be possible if the tab extended into the hollow interior of the drum over the full length of the tab.

The deeper portion 32b of each tab 32 that resides adjacent to one of the two ends 12a, 12b of the drum 12 defines a stop against which the respective end plate 20, 22 is axially abutted during assembly of the wheel. At the holes adjacent each end of the drum, the first legs 36a of the holes are situated nearer to the respective end of the drum than the second legs 36b, thereby setting the installed position of the respective end wall 20, 22 close to the respective end 12a, 12b of the drum 12. During the manufacture or assembly of the wheel, the holes 36 in the drum not only act to positively position the cleats during manufacture of the wheel, but they also cooperate with the step-shaped variable depth tabs in order to positively position the hub plate 14 and end plates 20, 22 accurately in the appropriate position for affixing to the drum.

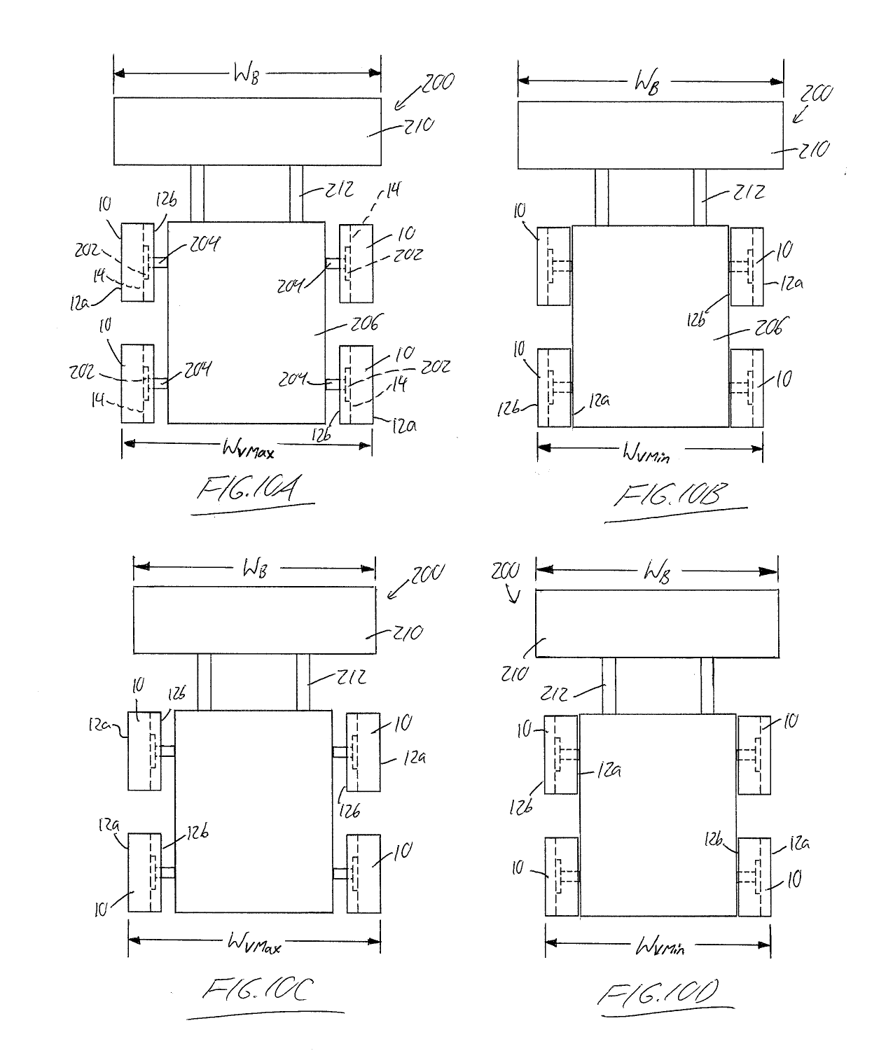

Turning to FIG. 9, a schematically illustrated skid steer vehicle 200 features a wheel hub 202 mounted to the end of a wheel axle 204 that projects laterally outward from a side of the main body 206 of the vehicle 200. The main body 206, shown schematically without detail, embodies the operator cabin, engine and other operational components of the skid steer. A plurality of wheel bolts or studs 208 project perpendicularly from a mounting face 202a of the wheel hub 202 that faces away from the main vehicle body 206. The spacing of the bolt holes 26 in the hub plate 14 of the wheel 10 is such that the wheel bolts 208 are alignable with respective bolt holes 26 of the wheel 10 to enable passage of the wheel bolts 208 through the bolt holes 26. Due to the offset position of the hub plate 14 inside the wheel drum 12, a first axial measure M₁ of the wheel from the hub plate 14 to the first end 12a of the drum 12 exceeds a second axial measure M₂ of the wheel from the hub plate 14 to the second end 12b of the drum 12. A clearance measurement C of the skid steer is measured from the plane of the wheel hub mounting face 202a to the nearest side of the main body 206 of the skid steer at the area thereof from which the wheel shaft 202 projects.

FIG. 9A illustrates a scenario in which the clearance C of a particular model of skid steer vehicle exceeds M₂, but not M₁. Since the first axial measure M₁ of the wheel exceeds the clearance C, the wheel cannot be mounted on the wheel hub with the first end 12a of the wheel facing toward the main body 206 of the skid steer vehicle 200, as shown in FIG. 9A. Accordingly, the wheel must be reversed from this orientation, as shown by arrow A₁, into the orientation of FIG. 9B, in which the second end 12b of the wheel drum 12 faces toward the main body 206 of the vehicle. The second end 12b of the wheel drum 12 can then be displaced over the wheel hub toward the main body 206 of the skid steer, as denoted by arrow A₂, in order to receive the wheel bolts 208 through the bolt holes 26 and abut the hub plate 14 against the mounting face 202a of the hub 202, whereupon suitable lug nuts (not shown) can be fastened onto the wheel bolts 208 to secure the wheel 10 in this installed position.

Accordingly, installation of the wheel on different models of skid steer involves the assessment of whether one or both of the axial measures M₁, M₂ is less than the available clearance C on the skid steer machine, and if only one of the two axial measures M₁, M₂ is less than the clearance measurement C (like in the scenario shown in FIG. 9), then the end of the drum 12 from which the shorter axial measurement M2 is taken is faced toward the main body 206 of the skid steer during the installation of the wheel onto the wheel hub 202.

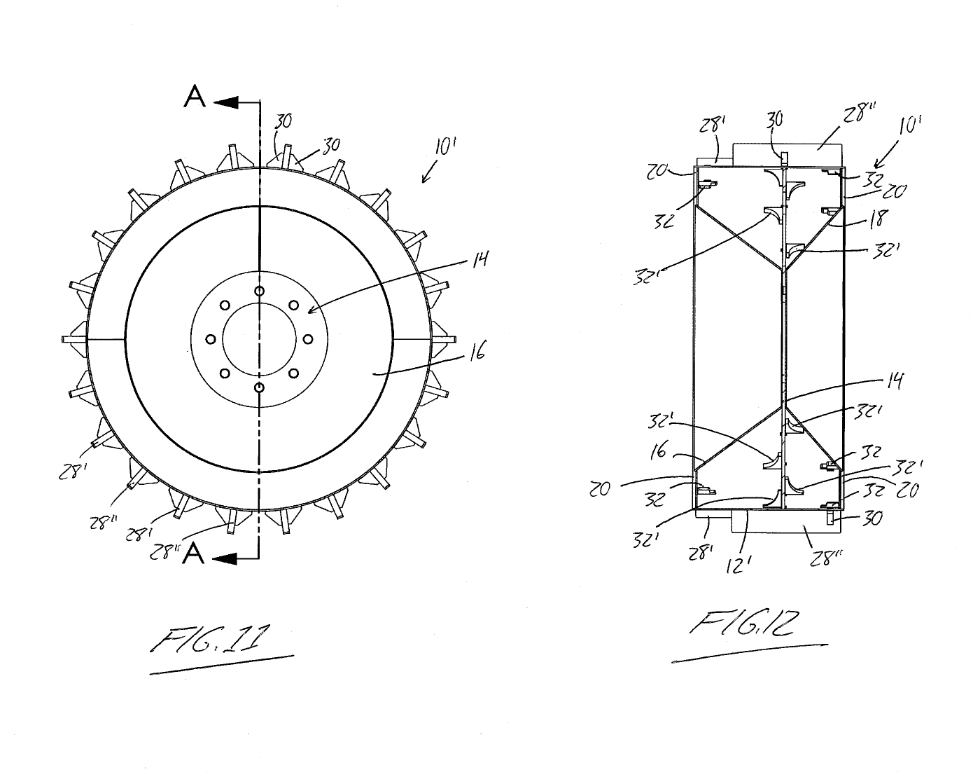

FIG. 10 schematically illustrates a different scenario in which both axial measures M₁, M₂ are less than the clearance measurement C of a skid steer, in which case the wheel can be mounted to the wheel hub in either orientation. The wheels 10 of the present invention are illustrated schematically in FIG. 10, where the cleats 24 are omitted for ease of illustration.

In this case, where both axial measures M₁, M₂ are less than the clearance measurement C of a skid steer, a user may select the mounting orientation of the wheel in accordance with a desired positional relationship between the bucket 210 (or other working attachment) carried on the lifting arms 212 of the skid steer. For example, it is undesirable to have the wheels 10 of the skid steer protrude laterally outward from the main body 206 beyond the vertical planes in which the ends 210a of the bucket reside, as this would mean that the wheels extend beyond a ground path being cleared by the bucket during use of the skid steer for ground clearing operations. On the other hand, it is considered undesirable to reduce the wheel-to-wheel distance unnecessarily, as the reduced wheel-to-wheel vehicle width W_{V} (measured from the outer end of a wheel on one side of the vehicle body 206 to the corresponding wheel on the other side of the vehicle body) reduces the roll stability of the vehicle. In the present invention, selection from among two possible wheel orientations that are enabled by the offset hub plate position of the wheel allows the user to set the wheel-to-wheel width of the vehicle, for example to optimize same relative to the bucket width W_{B} of the particular machine on which the wheels are being installed. The offset wheel hub not only allows the same model wheel to be used on different skid steer models, but also allows use of the same wheel with different bucket attachments, while striking a balance between the wheel/bucket clearance (W_{B}-W_{V}) and roll stability of the machine.

FIG. 10A schematically shows a scenario in which the maximum wheel-to-wheel vehicle width of the skid steer W_{VMax} achieved with the inventive wheels installed in positions facing their second ends 12b toward the main body of the vehicle (i.e. second-end-in) is less than the bucket width W_{B} of the skid steer. On the same machine, the minimum attainable wheel-to-wheel vehicle width W_{Min} achieved by mounting the wheels in the reverse orientation (first-end-in) would therefore also be less than the bucket width, as shown in FIG. 10B. Accordingly, a user would typically select the “second end in” orientation in order to achieve the maximum roll stability afforded by the maximum wheel to wheel vehicle width, without the detriment of having the wheel-to-wheel width exceed the blade width.

FIG. 10C schematically shows a scenario in which the maximum wheel-to-wheel vehicle width W_{MAX} of a different skid steer (or same skid steer with a different bucket attachment) exceeds the bucket width W_{B}, in which case a user would typically select the “first-end-in” orientation in order to adopt the minimum vehicle width W_{Min}, as shown in FIG. 10D, thereby either reducing or eliminating the amount by which the wheels reach beyond the ends of the bucket 210.

The offset configuration of the wheel therefore provides a flexible solution that allows use of the identical wheel in a number of different scenarios, as opposed to requiring a greater number of different wheel models for different skid steer machines. The annular end plates of each wheel provides the wheel with a greater thickness at its axial ends than that provided by the annular end of the drum 12 alone, whereby a tendency for the end of the wheel to dig into the ground is reduced. The frustoconical walls prevent loosened earth or other material from accumulating inside the drum in the space between the end plates and the hub plate, and also prevent any material from getting clogged in, or ejected from, the spoked areas of the hub plate in embodiments employing a spoked hub plate configuration. While the frustoconical walls could likewise be employed for similar purpose in embodiments lacking the annular end plates, the end plates again provide an advantageous anti-digging profile of greater thickness at the end of the wheel compared to other designs in which the frustoconical walls would join directly to the end of the drum and form a pointed edge.

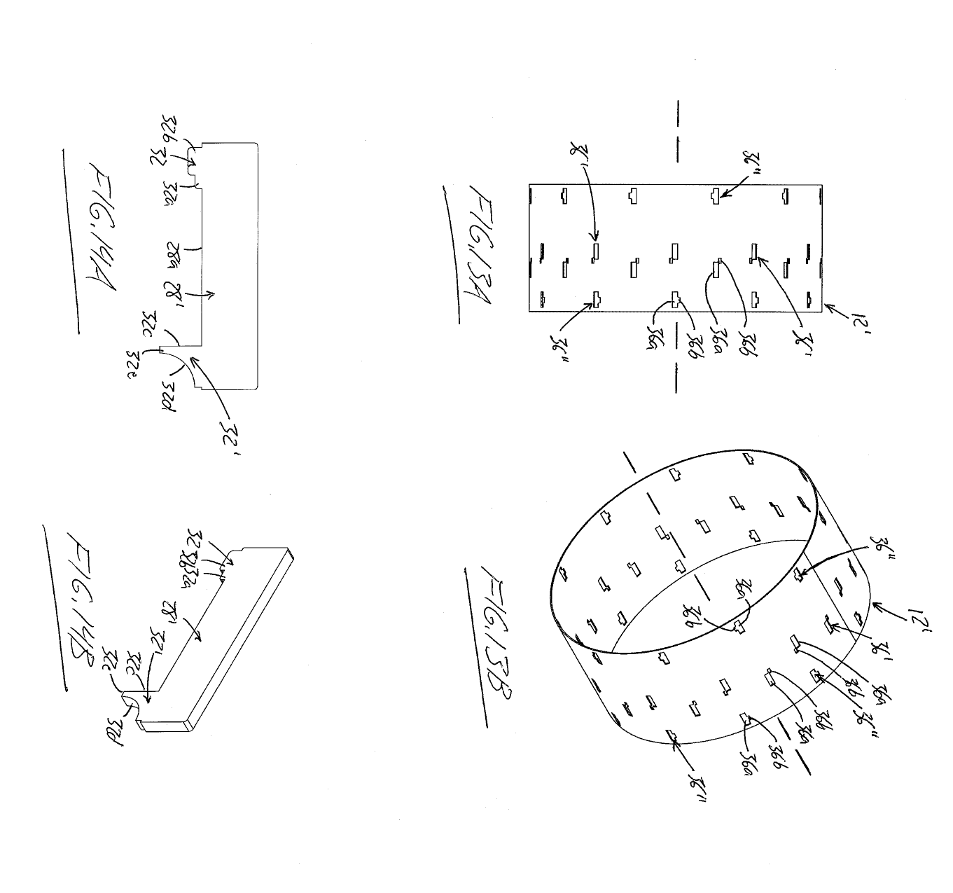

A second embodiment of the tireless wheel is illustrated in FIGS. 11 to 14 and features the same general arrangement of the circumferential drum, offset hub plate, annular end plates, and cleat plates and gussets mounted to the exterior of the drum via openings therein. The tireless wheel 10′ of the second embodiment differs from the first embodiment in that there are two different shapes of cleat plate, the two mounting tabs of each cleat plate are different shape from one another, the hub plate is abutted by mounting tabs of the cleat plates on both sides of the hub plate, one gusset of each cleat resides at the same plane as the hub plate, and the other gusset of each cleat resides closely adjacent the plane of the respective annular end wall. The side view of the second embodiment wheel 10′ in FIG. 11 illustrates how the overall structure and appearance of the fully assembled wheel closely matches that of the first embodiment.

Turning to FIGS. 13A and 13B, the openings 36′, 36″ in the drum 12′ are similar to those of the first embodiment in that each opening features a first leg 36a that extends axially of the drum, and a second leg 36b that is offset from the first leg 36a in the circumferential direction of the drum. However, the openings are not L-shaped, and the two openings for each cleat are not identical in shape. Instead, each pair of openings features an inner opening 36′ and corresponding outer opening 36″, of which the inner opening 36′ resides nearer to the axial center of the drum than the outer opening 36″, which in turn resides closely adjacent a respective end of the drum. The first leg 36a of the inner opening 36′ terminates at or closely adjacent the intermediate plane in which the hub plate 14 resides. The second leg 36b of the inner opening 36′ resides at the intermediate plane, and joins with the end of the first leg 36a at a corner thereof so as to be circumferentially offset from the first leg 36a to one side thereof. Instead of being L-shaped like in the first embodiment, each outer opening 36″ in the second embodiment is T-shaped, with the first leg 36a again lying axially of the drum and the second leg extending circumferentially from the first leg 36a, but at a midpoint therealong rather than at an end thereof. As in the first embodiment, the second legs 36h of the two openings in each pair are offset from their respective first legs in opposite circumferential directions around the drum.

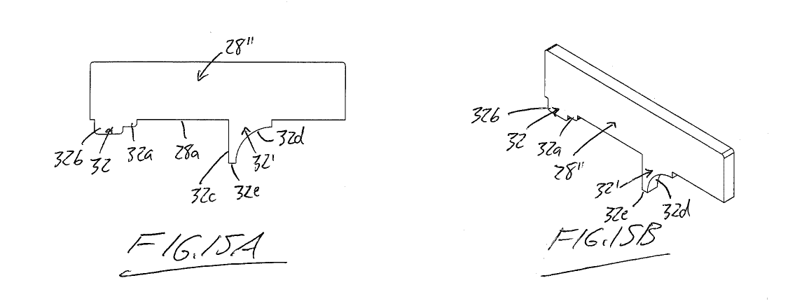

FIGS. 14 and 15 respectively show the two different cleat plates 28′, 28″ of the second embodiment. In both types, the two mounting tabs of each cleat plate 28′ include one mounting tab 32 that has the same shape as described for the first embodiment and that resides adjacent the outer end of the cleat that stands at the respective end of the drum in the assembled wheel. This mounting tab 32 thus serves as an end-plate mounting tab for abutment with the respective annular end plate 20 of the assembled wheel. The other gusset shaped tab 32′ resides closer to the opposing end of the cleat plate than the end plate mounting tab 32, and serves as a hub-plate mounting tab 32′ that abuts against the hub plate 14 of the assembled wheel. The gusset-shaped hub-plate mounting tab 32′ features a flat edge 32c projecting perpendicularly from the lengthwise edge 28a of the cleat place and facing toward the end-plate mounting tab 32. A sloped edge 32d of the gusset-shaped hub-plate mounting tab slopes outwardly toward a distal end of the flat edge 32c from a side thereof opposite the end-plate mounting tab 32. The sloped edge 32d of the illustrated hub-plate mounting tab 32′ is concavely sloped, but need not necessarily have this shape, and instead may be linearly sloped, for example.

The two different cleats shown in FIGS. 14 and 15 have the same length, and differ from one another only in the inter-tab distance measured between the two mounting tabs 32, 32′ along the lengthwise edge 28a. The cleat 28′ of FIG. 14 has a longer inter-tab distance than the cleat 28″ of FIG. 15. During assembly of the wheel, the longer inter-tab cleats 28′ of FIG. 14 have their end-plate mounting tabs 32 placed in the T-shaped slots 36″ adjacent the end of the drum furthest from the hub plate 14. Considering the drum to be divided into two unequal halves by the offset hub plate 14, the longer inter-tab cleats 28′ thus fully span the axially-deeper half of the drum, while only partially spanning the axially-shallower half of the drum. The shorter inter-tab cleats 28″ of FIG. 15 have their end plate mounting tabs 32 placed in the T-shaped slots 36″ adjacent the end of the drum nearest the hub plate, whereby the shorter inter-tab cleats 28″ thus fully span the axially-shallower half of the drum, and only partially span the axially-deeper half of the drum.

In the fully assembled drum, the hub-plate mounting tab 32′ of each cleat 28′, 28″ abuts against the side of the hub plate 14 that is opposite to the end-plate mounting tab 32 of that cleat. Accordingly, the flat edges of the hub-plate mounting tabs 32′ of the longer inter-tab cleats 28′ abut against hub plate at the axially-shallower half of the drum, while the flat edges of the hub-plate mounting tabs 32′ of the shorter inter-tab cleats 28″ abut against hub plate at the axially-deeper half of the drum. The hub-plate mounting tabs 32′ of both sets of cleats thus define gussets that reinforce the hub plate from opposing sides thereof. To assemble the wheel, one set of cleats is first installed on the respective half of the drum, and then the hub plate is inserted into the other half of the drum into a seated position against the hub plate mounting tabs of the first set of cleats. This positions the hub plate in the appropriate intermediate plane, at which point the second set of cleats can then be installed. The gusset-defining hub-plate mounting tabs 32′ of both sets of cleats are preferably welded to the hub plate 14.

In the second embodiment, one of the two gussets 30 of each cleat is located at the same intermediate plane of the drum as the hub plate 14 so that this gusset resides in coplanar relationship with the hub plate 14. These gussets at the intermediate plane reside closer to the axial center of the drum, and are therefore referred to herein as inner gussets, whereas the other gussets reside closer to the ends of the drum and are therefore referred to as outer gussets. Due to its placement at the intermediate plane in the second embodiment, the inner gusset of each cleat resides at an area of the drum that is radially reinforced by the hub plate 14, thereby providing optimal handling of the loads exerted on the cleats during use of the wheel. In addition, the circumferentially offset legs 32b of the T-shaped openings 36″ in the drum of the second embodiment are located nearer to the ends of the drum 12′ than the offset legs 32b of the L-shaped openings in the first embodiment drum, whereby the outer gussets 30 of the second embodiment resides closer to the end plates 20 than in the first embodiment. Accordingly, the outer gussets 30 in the second embodiment are likewise situated at an internally reinforced area of the drum to better maintain the radial orientation of the cleats during loading thereof.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A tireless skid steer wheel comprising:
a cylindrical drum closing around a central axis and spanning between opposing first and second ends of said cylindrical drum that are spaced apart along said central axis;
a plurality of cleats attached to the cylindrical drum and projecting externally therefrom at spaced apart positions around a circumference thereof;
a hub plate attached to, and disposed within, the cylindrical drum at an intermediate location between the opposing first and second ends thereof in an intermediate plane lying normal to the central axis;
a first frustoconical wall closing around the central axis on a first side of the hub plate with a wider end of said first frustoconical wall disposed in a first end plane lying normal to the central axis at or adjacent the first end of the cylindrical drum, and a narrower end of said first frustoconical wall disposed adjacent the hub plate in a first inner plane lying normal to the central axis and adjacent to the intermediate plane; and
a second frustoconical wall closing around the central axis on a second side of the hub plate with a wider end of said second frustoconical wall disposed in a first end plane lying normal to the central axis at or adjacent the second end of the cylindrical drum, and a narrower end of said second frustoconical wall disposed adjacent the hub plate in a second inner plane lying normal to the central axis and adjacent to the intermediate plane;
wherein the intermediate plane lies at an off center position located non-centrally between the first and second ends of said cylindrical drum along the central axis, and the first and second frustoconical walls are unequal to one another in an angle of taper measured between the wider and narrower ends of each frustoconical wall.

2. The tireless skid steer wheel of claim 1 further comprising:
a first annular plate joining the wider end of the first frustoconical wall to the first end of the cylindrical drum; and
a second annular plate joining the wider end of the second frustoconical wall to the second end of the cylindrical drum.

3. The tireless skid steer wheel of claim 1 wherein each cleat comprises a cleat plate having a length that lies axially of the drum and a width that lies radially of the drum, the plate comprising a pair of tabs that are disposed at spaced apart locations along the length of the plate are engaged into a respective pair of openings in the circumference of the drum.

4. The tireless skid steer wheel of claim 3 wherein each cleat further comprises a pair of gussets disposed on opposite sides of the cleat plate in a bracing relationship between the cleat plate and the circumference of the drum, and at least some of the openings in the circumference of the drum each comprise a first leg of the opening that lies axially of the drum to accommodate receipt of one of the tabs of the respective cleat and a second leg of the opening that is offset from the first leg in a circumferential direction of the drum to accommodate receipt of an additional tab on one of the gussets of the respective cleat.

5. The tireless skid steer wheel of claim 1 wherein at least some of the cleats each having a hub-plate mounting portion thereof that extends fully through a respective opening in the drum into a hollow interior space thereof, and the hub plate axially abuts said hub-plate mounting portion inside the hollow interior space of the drum.

6. The tireless skid steer wheel of claim 5 said at least some of the cleats comprise a first group of cleats whose hub-plate mounting portions abut the hub plate from a first side thereof and a second group of cleats whose hub-plate mounting portions abut the hub plate from an opposing second side thereof.

7. The tireless skid steer wheel of claim 6 wherein the first group of cleats and the second group of cleats alternate with one another around the circumference of the drum.

8. The tireless skid steer wheel of claim 5 wherein the hub-plate mounting portion of each of said some of the cleats is gusset-shaped.

9. The tireless skid steer wheel of claim 1 comprising a first annular plate joining the wider end of the first frustoconical wall to the first end of the cylindrical drum and a second annular plate joining the wider end of the second frustoconical wall to the second end of the cylindrical drum, wherein at least some of the cleats each have an end plate mounting portion thereof that extends fully through a respective opening in the drum into a hollow interior space thereof, and one of the annular plates abuts axially against said mounting portion.

10. The tireless skid steer wheel of claim 1 wherein a length of cleat measured in an axial direction of the drum is less than an axial length of the drum and greater than ⅔ of said axial length of the drum, and the plurality of cleats are laid out in a staggered pattern in which sequentially adjacent cleats around the circumference of the alternate between a first position adjacent the first end of the drum and a second position adjacent the second end of the drum.

11. The tireless skid steer wheel of claim 1 wherein each cleat comprises a cleat plate and a pair of gussets disposed on opposite sides of the cleat plate in a bracing relationship between the cleat plate and the circumference of the drum.

12. The tireless skid steer wheel of claim 11 wherein the gussets comprise inner gussets that reside in a same plane as the hub plate.

13. The tireless skid steer wheel of claim 11 comprising a first annular plate joining the wider end of the first frustoconical wall to the first end of the cylindrical drum and a second annular plate joining the wider end of the second frustoconical wall to the second end of the cylindrical drum, wherein the gussets comprise outer gussets that each reside in a same plane as one of the annular end plates.

14. The tireless skid steer wheel of claim 1 wherein the hub plate has a spoked configuration featuring an inner portion in which a plurality of bolt holes are provided for mounting the tireless skid steer wheel to a wheel hub of a skid steer, and a plurality of radial spokes emanating outwardly toward the drum from the central portion at spaced apart positions around the central axis.

15. A tireless skid steer wheel comprising:
a cylindrical drum closing around a central axis and spanning between opposing first and second ends of said cylindrical drum that are spaced apart along said central axis;
a plurality of cleats attached to the cylindrical drum and projecting externally therefrom at spaced apart positions around a circumference thereof;
a hub plate attached to, and disposed within, the cylindrical drum at an intermediate location between the opposing first and second ends thereof in an intermediate plane lying normal to the central axis;
a first frustoconical wall closing around the central axis on a first side of the hub plate with a wider end of said first frustoconical wall disposed in a first end plane lying normal to the central axis at or adjacent the first end of the cylindrical drum, and a narrower end of said first frustoconical wall disposed adjacent the hub plate in a first inner plane lying normal to the central axis and adjacent to the intermediate plane; and
a second frustoconical wall closing around the central axis on a second side of the hub plate with a wider end of said second frustoconical wall disposed in a first end plane lying normal to the central axis at or adjacent the second end of the cylindrical drum, and a narrower end of said second frustoconical wall disposed adjacent the hub plate in a second inner plane lying normal to the central axis and adjacent to the intermediate plane;
a first annular plate joining the wider end of the first frustoconical wall to the first end of the cylindrical drum; and
a second annular plate joining the wider end of the second frustoconical wall to the second end of the cylindrical drum.

16. A tireless skid steer wheel comprising:
a cylindrical drum closing around a central axis and spanning between opposing first and second ends of said cylindrical drum that are spaced apart along said central axis;
a plurality of cleats attached to the cylindrical drum and projecting externally therefrom at spaced apart positions around a circumference thereof; and
a hub plate attached to, and disposed within, the cylindrical drum at an intermediate location between the opposing first and second ends thereof in an intermediate plane lying normal to the central axis;
wherein each cleat comprises a cleat plate extending axially of the drum and a pair of gussets abutted against the cleat plate on opposing sides thereof in a bracing relationship between the cleat plate and the circumference of the drum.

17. The tireless skid steer wheel of claim 16 wherein the drum comprises a respective pair of openings therein for each cleat, each opening comprising a first leg of the opening that extends axially of the drum and a second leg of the opening that is offset from the first leg in a circumferential direction of the drum, each cleat plate has a pair of tabs projecting from an edge of the plate into the respective pair of openings in the cylindrical drum, and each gusset has an additional tab at a corner of the gusset defined between an edge of the gusset that abuts the cleat plate and an edge of the gusset that abuts the circumference of the drum, the additional tab projecting into one of the respective pair of openings at the second leg thereof.

18. The tireless skid steer wheel of claim 19 wherein the gussets comprise inner gussets that reside in a same plane as the hub plate.

19. The tireless skid steer wheel of claim 19 comprising first and second annular end plates extending radially inward from the drum adjacent the first and second ends thereof, wherein the gussets comprise outer gussets that each reside in a same plane as one of the annular end plates.

20. A wheel installation method for a skid steer having wheel hubs situated outboard from a main body of the skid steer, the method comprising:
(a) having a tireless skid steer wheel comprising a cylindrical drum, a plurality of cleats attached to the cylindrical drum and projecting externally therefrom at spaced apart positions around a circumference thereof, and a hub plate attached to, and disposed within, the cylindrical drum at an offset position from an axial center of the cylindrical drum such that a first axial measure of the drum from a first end of the drum to the hub plate is unequal to a second axial measure of the drum from an opposing second end thereof to the hub plate; and
(b) selecting which one of the ends of the drum to face toward the main body of a particular skid steer during installation according to dimensional characteristics of said particular skid steer;
(c) installing the wheel on the particular skid steer with the selected one of the ends facing toward the main body of the skid steer.

21. The method of claim 20 wherein the first axial measure is greater than the second axial measure, and wherein step (b) comprises (i) determining that only the second axial measure is less than an available clearance between a mounting face of the wheel hub and a side of the main body of the skid steer, and (ii) selecting the second end of the drum as the selected one of ends for facing toward the main body of the skid steer in step (c).

22. The method of claim 20 wherein step (b) comprises:
(i) determining that a wheel-to-wheel vehicle width of the particular skid steer that would result from installation of the wheel in a second-end-in orientation facing the second end of the drum toward the main body of the skid steer would exceed a bucket width of the skid steer; and
(ii) selecting the first end of the drum as the selected one of ends for facing toward the main body of the skid steer in step (c).

23. The method of claim 20 wherein step (b) comprises:
(i) determining that a wheel-to-wheel vehicle width of the particular skid steer that would result from installation of the wheel would be less than a bucket width of the skid steer regardless of which end of the drum is faced toward the main body of the skid steer during installation; and
(ii) selecting which end of the drum to face toward the main body in the skid steer in step (c) based as that which will result in the greater wheel-to-wheel vehicle width.
